(19) United States
(12) Patent Application Publication
(10) Pub. No.: US 2013/0319183 A1
(43) Pub. Date: Dec. 5, 2013

(54) Apparatus and Methods for threading a nut along an elongate member

(71) Applicant: Don K. Clover, Katy, TX (US)

(72) Inventor: Don K. Clover, Katy, TX (US)

(21) Appl. No.: 13/507,102

(22) Filed: Jun. 4, 2012

(51) Int. Cl. B25B 21/00

(52) U.S. Cl. 81/57.44; 81/54; 173/1

(57) ABSTRACT

Apparatus and methods for threading a nut along a stud or similar elongate member include use of a contact member within a first orifice that engages the nut, and a torque transfer member within a second orifice that engages both the contact member and a power source, such as an air ratchet. Torque from the power source causes movement of the torque transfer member, which in turn causes movement of the contact member, thereby threading or unthreading the nut along the stud or other elongate member. The first orifice includes a through bore for accommodating passage of the elongate member, while the body of the apparatus can include ferromagnetic members for preventing loss of the nut and additional structures for limiting undesired movement of the power source or apparatus through contact.

### FIELD

Embodiments usable within the scope of the present disclosure relate, generally, to apparatus and methods for applying a force (e.g., torque) to an object, and more specifically, to apparatus and methods for threading a nut along an elongate member, such as when securing a flange.

### BACKGROUND

Attachment of adjacent segments of a conduit having flanges is generally performed by abutting the flanges of two conduit segments, such that a series of bores extending through the flanges are aligned to create a continuous through-hole that extends through the flanges of both conduit segments. When attaching a single conduit segment to an object or a surface, the bores through the conduit flange can be aligned with receiving holes in the object to which the conduit segment is to be secured. In either case, through aligned these holes, a stud having external threads is positioned, the stud extending a significant length beyond the upper surface of the flange(s). Using the studs, the flanges of a conduit segment can be secured in an abutting relationship, by threading one or more nuts, or similar fasteners, along the stud until the nuts abut the flanges.

Forming an attachment of this nature is normally very time consuming and tedious, primarily due to the large number of nuts that must be threaded in this manner to make a single connection. A typical flanged connection may require installation of a dozen or more studs, and the threading and torquing of twice that number of nuts, one on each stud, on each side of the flanged connection. When it is necessary to unmake a connection (e.g., when a segment of conduit requires replacement), it is equally time consuming and tedious to unthread the nuts along the full length of the studs.

As an alternative to manually threading and unthreading nuts along their respective studs, pneumatic nut runners can be used to rapidly spin the nuts. However, many limited access locations include closely-spaced flanges and objects, where insertion of such a device and placement of the device over a stud would be difficult, if not impossible. Additionally, it is common for many nuts to be dropped and/or otherwise lost when being positioned for engagement or shortly after disengagement from a stud. Further, use of a nut running device can sometimes result in damage or injury when installing a nut, e.g., when the nut abuts the flange and the continued force generated by the device causes the device to forcefully contact an adjacent object.

A need exists for apparatus and methods usable to rapidly engage and disengage nuts or similar members along a stud, usable within limited access and/or low-clearance areas.

A further need exists for apparatus and methods usable to retain a nut therewith when moving the nut into and from engagement with a stud.

A need also exists for apparatus and methods usable to limit undesired movement of a device relative to the nut being engaged, e.g., after abutment of the nut against a flange or other object.

Embodiments usable within the scope of the present disclosure meet these needs.

### SUMMARY

Embodiments usable within the scope of the present disclosure include apparatus and methods for threading nuts or similar objects along an elongate member (e.g., a stud). Generally, an apparatus having a body with a first and second orifice formed therein is provided, the first orifice having a contact member for engaging a nut and transferring torque thereto, and the second orifice having a torque transfer member in association therewith. A power source (e.g., an air ratchet) can be engaged with the torque transfer member (e.g., through the second orifice), such that actuation of the power source causes movement (e.g., rotation) of the torque transfer member. The torque transfer member can in turn be engaged with the contact member (e.g., through a geared arrangement with interlocking teeth, or similar means), such that the contact member moves responsive to actuation of the power source. The contact member can be shaped for engaging the nut, such as through inclusion of an interior, hexagonal profile for engagement with a hex nut, such that movement of the contact member causes rotation of the nut.

The body of the apparatus can be provided with a tapered shape, e.g., having a first width at a first end and a second, lesser width at a second end. The body can further be provided with a generally short height (e.g., a low clearance) to facilitate access between closely-spaced flanges and/or objects. For example, the thickness of a nut used in most applications is generally equal to the diameter of the stud, to facilitate proportionality of the thread width of the stud relative to the nut. To ensure the ability of the body to access a space through which a nut will be installed, the body of the apparatus can be provided with a thickness less than or equal to that of the nut, such that the body of the apparatus is capable of accessing any space able to be accessed by the nut. Similarly, the body of the apparatus can be provided with a width selected to fit between adjacent nuts on either side thereof, disposed on a flange, the distance between nuts corresponding to API standards, ANSI standards, and/or other similar standards

To prevent undesired movement of the power source relative to the body and/or the power source or body relative to the nut, the power source can be fixedly engaged with the torque transfer member, e.g., through the second orifice, such as through attachment of a frame or similar member over the power source, the frame being connected to the body. In an embodiment, the power source can be removably and interchangeably engaged with the body for enabling efficient replacement and/or selective use of power sources having desired characteristics. For example, while in a preferred embodiment, the power source can include an air ratchet, in other embodiments, an electrical power source can be used. Typically, an electrical power source can produce torque efficiently per unit of power consumed, and relative to the size of the power source. Alternatively or additionally, one or more blocking members can be attached to the body, the blocking members extending on one or both sides of the power source, such that lateral movement of the power source will impact the blocking member, thus limiting movement of the power source in a manner that could cause damage or injury. Similarly, lateral movement of the apparatus, itself, e.g., immediately after a nut contacts a flange, can be prevented through contact between the blocking member and the conduit and/or adjacent studs or nuts.

In an embodiment, the contact member and/or another portion of the first orifice can include one or more ferromagnetic members (e.g., magnets) embedded therein or placed thereon, usable to retain the nut within the orifice. Use of magnets or similar ferromagnetic members in this manner enables retention of the nut within the orifice during movement and transit of the apparatus. For example, it is common for a nut to be inadvertently dropped when moving a nut runner having the nut therein into a position for engagement with a stud. Similarly, after disengaging a nut, it is common for the nut to fall from the orifice when attempting to move the nut runner away from the stud. Use of ferromagnetic members enables the nut to be securely placed in the orifice, both before engagement and after disengagement, and moved into and from a position suitable for engagement with the stud, the magnetic members retaining the nut within the orifice during movement of the apparatus. The first orifice, body, and/or contact member can further include stand-off members (e.g., bolts or similar contact members), which urge the apparatus, the magnets, and/or the nut apart from one another one the nut is engaged, e.g., through continued application of force by the power source.

As such, an embodied apparatus usable within the scope of the present disclosure can be provided into engagement with a nut, e.g., through engaging a nut with the contact member of the apparatus, and providing a power source into engagement with the torque transfer member. Once the apparatus and nut are positioned for engagement with a stud or similar elongate member, the power source can be actuated to cause movement of the torque transfer member, thereby causing movement of the contact member, which in turn contacts and moves the nut along the stud while the stud passes through the through-bore of the orifice within which the nut is retained. As described previously, embodiments of the present apparatus can be used bidirectionally, such that nuts can be disengaged through the reverse process. Conventional nut runners must be inverted or otherwise reconfigured to turn a nut in the reverse direction, while embodiments of the present apparatus can be bidirectionally operable.

Embodied methods of use can also include methods for threading and/or otherwise moving a stud or similar elongate member, relative to one or more nuts. For example, a nut can be threaded along a stud along which an additional nut has been positioned. When the first nut contacts the additional nut, further movement of the nut along the stud is impeded; however, continued actuation of the power source can cause forces to be transmitted through the nut to the stud, causing rotation of the stud for threading (or unthreading) the stud into a flange or similar receptacle.

Embodiments usable within the scope of the present disclosure thereby provide apparatus and methods usable to rapidly move nuts along a stud or similar member, bidirectionally, that are usable within low-clearance areas, and that can include features for limiting undesired movement and/or loss of the nut, and/or limiting undesired movement of the apparatus.

### BRIEF DESCRIPTION OF THE DRAWINGS

In the detailed description of various embodiments usable within the scope of the present disclosure, presented below, reference is made to the accompanying drawings, in which:

FIG. 1 depicts an exploded view of an embodiment of an apparatus usable within the scope of the present disclosure.

FIG. 2 depicts a front view of an embodiment of an apparatus usable within the scope of the present disclosure.

FIG. 3A depicts a side view of an embodiment of an apparatus usable within the scope of the present disclosure.

FIG. 3B depicts a perspective view of the apparatus of FIG. 3A.

FIG. 4 depicts an exploded view of an embodiment of an apparatus usable within the scope of the present disclosure.

FIG. 5A depicts a perspective view of an embodiment of an apparatus usable within the scope of the present disclosure.

FIG. 5B depicts a top view of the apparatus of FIG. 5A.

FIG. 5C depicts a side view of the apparatus of FIG. 5A.

FIG. 5D depicts a bottom view of the apparatus of FIG. 5A.

FIG. 6 depicts an exploded view of the apparatus of FIG. 5A.

One or more embodiments are described below with reference to the listed Figures.

### DETAILED DESCRIPTION OF THE EMBODIMENTS

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended to illustrate and plainly disclose presently preferred embodiments to one of skill in the art, but are not intended to be manufacturing level drawings or renditions of final products and may include simplified conceptual views as desired for easier and quicker understanding or explanation. As well, the relative size and arrangement of the components may differ from that shown and still operate within the spirit of the invention.

Moreover, it will be understood that various directions such as “upper,” “lower,” “bottom,” “top,” “left,” “right,” and so forth are made only with respect to explanation in conjunction with the drawings, and that the components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

Embodiments usable within the scope of the present disclosure relate to apparatus and methods for applying torque and/or other forces to a first object to move the first object relative to a second object. Specific embodiments, include an apparatus for threading and/or unthreading a nut along a stud, such as when securing a flange to an abutting flange or other object.

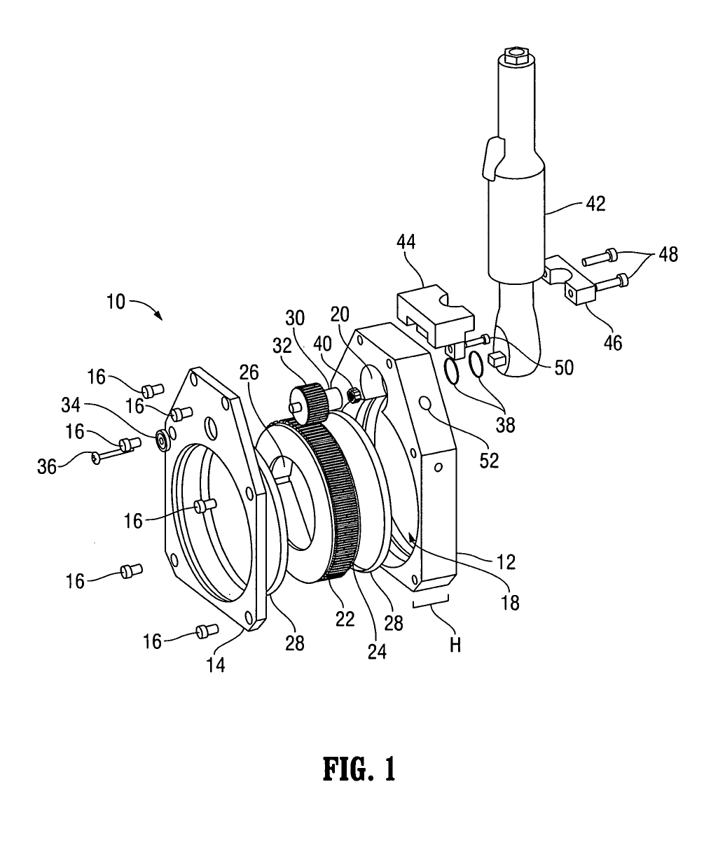

Referring now to FIG. 1, an exploded view of an embodiment of a nut running apparatus (10) is shown, the apparatus including a body (12) to which a top plate (14) can be secured, such as through use of multiple screws (16), bolts, rivets, and/or similar types of fasteners known in the art. The body (12) is shown having a generally tapered shape, with a wide front end that tapers toward a narrower back end. Also of note, the body (12) is shown having a generally limited profile height (H) for facilitating insertion thereof into low-clearance areas. Typically, the height (H) can be less than or equal to that of a nut to be secured using the apparatus (10). While FIG. 1 depicts a body (12) and front plate (14) having a generally hexagonal shape, with a back end narrower than the front end thereof, secured together using six screws (16), it should be understood that embodiments usable within the scope of the present disclosure can include any shape and/or dimensions, as desired, to facilitate access to a stud or similar elongate member, and transmission of torque form a power source to a nut for engagement therewith.

The body (12) includes a first orifice (18) formed therein, and a second orifice (20) adjacent thereto. In the depicted embodiment, the first and second orifices (18, 20) intersect to form a contiguous orifice; however, it should be understood that any placement and/or arrangement of orifices can be used without departing from the scope of the present disclosure. A contact member (22) is shown sized for placement within the first orifice (18). Specifically, the contact member (22) is depicted as a ring-shaped member having teeth (24) on the exterior surface thereof, and a hexagonal contact surface (26) on the interior surface thereof adapted for engaging and transmitting torque to a hex nut or similar fastener. Other types of contact surfaces can be usable for engaging nuts and/or fasteners having other shapes and/or external features. Two bushings (28) and/or other covers or spacing members can be used to secure the contact member (22) within the body (12) in a manner that permits rotation of the contact member (22). All or a portion of the hexagonal contact surface (26), and/or any portion of the body (12) within or proximate to the first orifice (18) can be magnetic and/or can include ferromagnetic elements for retaining a nut during movement of the apparatus (10).

A torque transfer member (30) is shown sized for placement within the second orifice (20), the depicted torque transfer member (30) shown as a ring and/or disc-shaped member having teeth (32) on an exterior surface thereof. A bearing (34), screw (36), two bushings (38) and/or guides, and a hex nut (40) can be used to secure the torque transfer member (30) within the body (12) in a manner that permits rotation thereof, though other methods of securing known in the art are also usable. When the torque transfer member (30) is secured within the second orifice (20) and the contact member (22) is secured within the first orifice (18), the teeth (32) of the torque transfer member (30) interlock with the teeth (24) of the contact member (20), such that rotation of the torque transfer member (30) causes rotation of the contact member (20), which can in turn cause rotation of a nut engaged with the contact surface (26) thereof.

FIG. 1 further depicts an air ratchet (42) positioned for engagement with the body (12) such that an operative portion thereof (e.g., a rotatable square pin) is engageable with a corresponding orifice of the torque transfer member (30). While a portion of the air ratchet (42) engages the torque transfer member (30) through the second orifice (20), the body of the air ratchet (42) can be secured to the body (12) of the apparatus to prevent undesired movement of the air ratchet (42) relative to the body (12). Specifically, FIG. 1 depicts a frame having a first portion (44) and a second portion (46) sized to encircle the body of the air ratchet (42), the portions (44, 46) being secured together using screws (48) or similar fasteners. The frame is shown secured to the body (12) using an additional screw (50) extending through the first portion (44). Securing the air ratchet (42) to the body (12) can prevent undesired movement (e.g., rotation) of the air ratchet (42) relative to the body (12), such as when a nut is tightened to abut a flange, and a sudden torque force is applied to the apparatus (10) when the nut will no longer move along the stud. The frame can be removable to facilitate interchangeability of the air ratchet (42), e.g., when different forces and/or different types of power sources are desired. It should be understood that while FIG. 1 depicts an air ratchet (42) removably secured to the body (12) using a two-part frame, in various embodiments, other pneumatic and/or other types of power sources (e.g., electrical, hydraulic, mechanical, and/or other power sources) could be used in lieu of the depicted air ratchet (42), and any means of connection and/or engagement known in the art and/or other methods for limiting undesired movement of the power source relative to the body (12) can be used. For example, FIG. 1 depicts a receiving bore (52) within the body (12), usable to receive a blocking member for limiting lateral movement of the air ratchet (42) relative to the body (12).

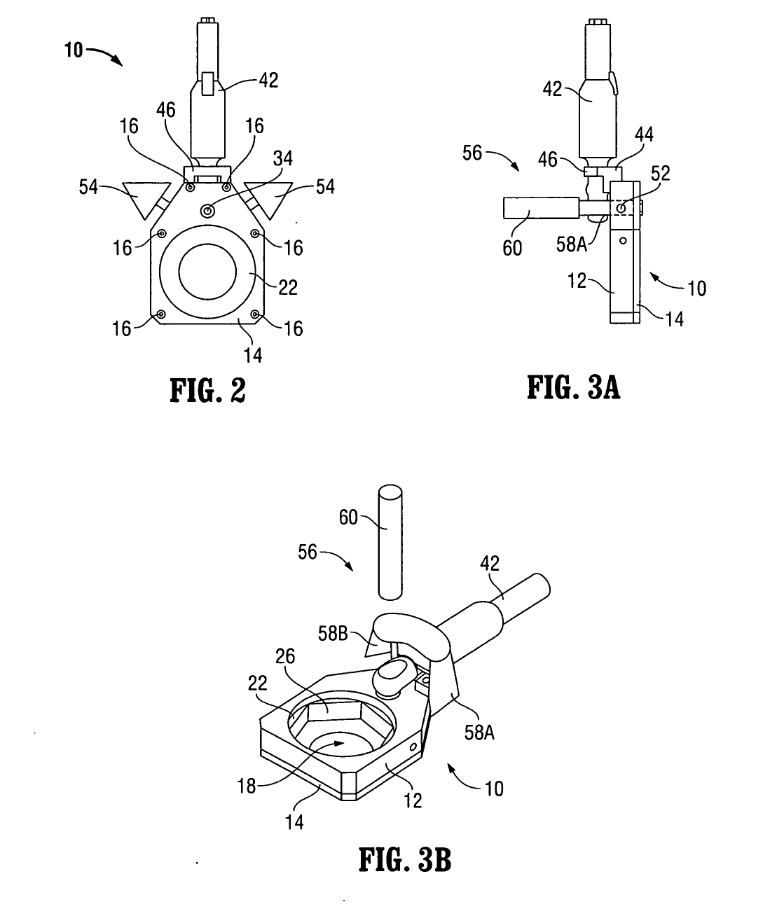

Referring now to FIG. 2, a front view of an embodiment of the apparatus (10) is shown, in which the front plate (14), screws (16), and bearing (34) are visible, and the air ratchet (42) is shown secured to the apparatus (10) using the frame, of which the second portion (46) is visible. Two blocking members (54) are shown, each threaded and/or otherwise secured into a receiving bore (52, shown in FIG. 1). The position of the blocking members (54) prevents undesired lateral movement of the air ratchet (42) relative to the remainder of the apparatus (10). For example, when threading a nut along a stud, at the moment the nut abuts the flange or another similar object, continued actuation of the air ratchet (42) will cause a sudden torque force to be experienced by a user holding the air ratchet (42) or other portion of the apparatus (10). This force can cause the air ratchet (42), the apparatus (10), or a portion of the user's body to move suddenly, possibly with great force, to impact a nearby object, especially when the apparatus (10) is used in a location with limited clearance and/or access. In the depicted embodiment, lateral movement of the air ratchet (42) relative to the remainder of the apparatus (10) will cause the air ratchet (42) to impact one of the blocking members (54), thereby limiting movement thereof. Further, lateral movement of the apparatus (10) itself, relative to the flange and/or other object being secured will cause one of the blocking members (54) to impact an adjacent nut and/or stud, the conduit, and/or another portion associated with the flange as the apparatus (10) moves laterally and/or rotationally. Limiting movement of the apparatus (10) and/or air ratchet (42) in this manner can prevent damage thereto and/or injury to a user. While FIG. 2 depicts two blocking members (54), it should be understood that a single blocking member can effectively limit movement of the air ratchet (42) and/or apparatus (10), such as during operations when torque is applied by the air ratchet (42) in a single direction.

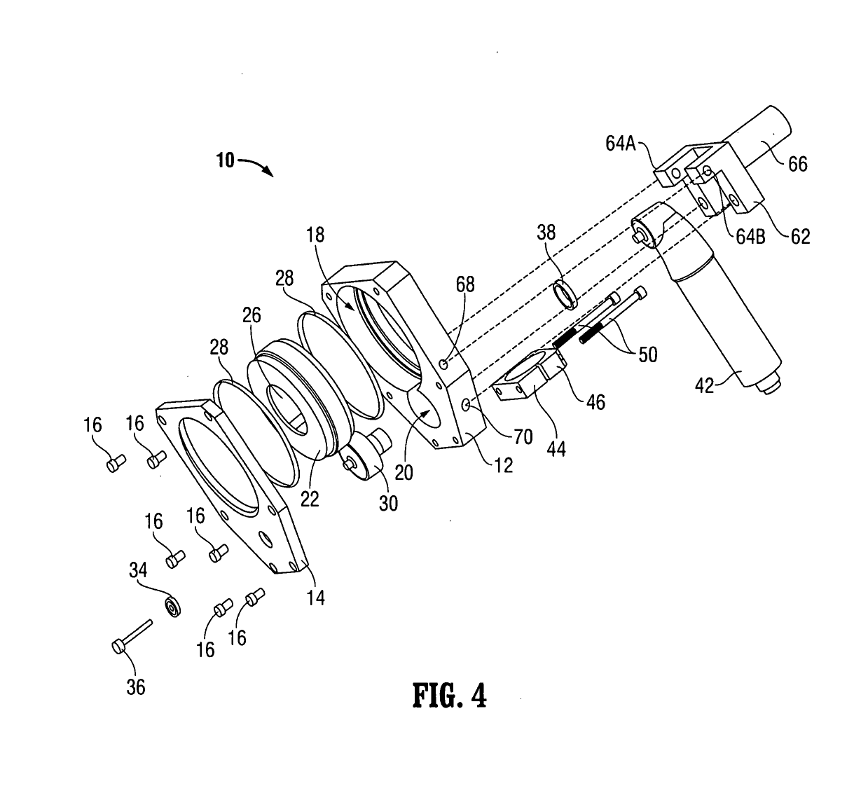

Referring now to FIGS. 3A and 3B, a side view and a perspective view, respectively, of an embodiment of the apparatus (10) is shown, in which the body (12) and front plate (14) are visible. The contact member (22), having inner surface (26), is shown disposed within the first orifice (18) of the body, as described previously, and the air ratchet (42) is shown secured to the body (12) by frame portions (44, 46). In the depicted embodiment, a reaction member (56) is shown, usable to prevent undesired lateral and/or rotational/angular movement of the air ratchet (42) and/or the apparatus (10). Specifically, the reaction member (56) is shown having two side plates (58A, 58B), which can engage respective bores (52, shown in FIG. 1) of the body (12). Alternatively, the side plates (58A, 58B) can simply be positioned on the sides of the body (12), while the reaction member (56) is attached to the apparatus (10) at one or more other locations. While FIGS. 3A and 3B depict side plates (58A, 58B) on both sides of the body (12), it should be understood that a single side plate can effectively limit movement of the air ratchet (42) and/or apparatus (10), such as during operations when torque is applied by the air ratchet (42) in only a single, known direction. The reaction member (56) is also shown including a removable handle (60), usable to provide the apparatus (10) with an additional location for gripping and/or manipulating the apparatus (10), and/or to enable the reaction member (56) to be used without providing direct engagement between the apparatus (10) and reaction member (56).

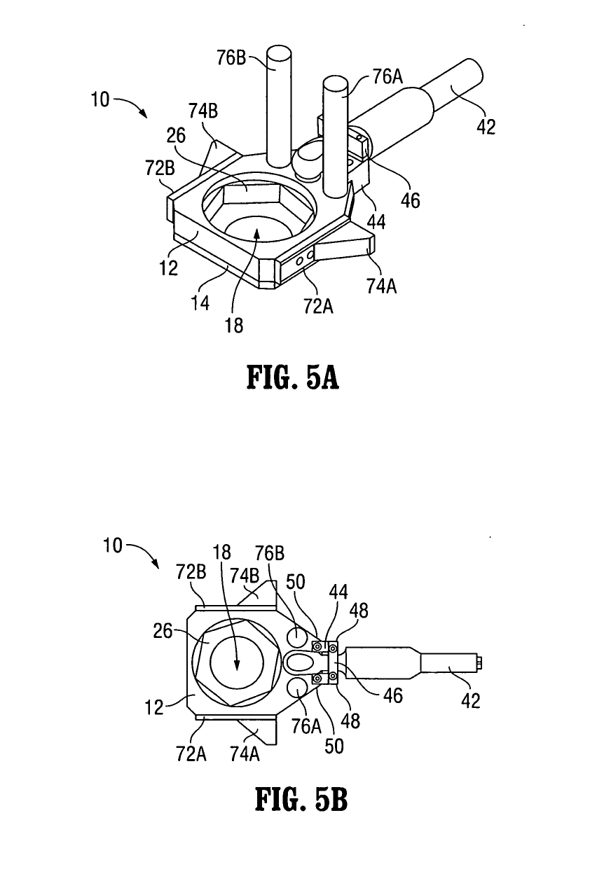

Referring now to FIG. 4, an exploded view of an alternate embodiment of a nut running apparatus (10) is shown. Similar to the previously depicted embodiments, the apparatus (10) includes a body (12) attachable to a front plate (14), e.g., via one or more screws (16) or similar connectors and/or fasteners. The body (12) includes a first orifice (18) within which a contact member (22) having an interior contact surface (26) is placed, between two bushings (28), and a second orifice (20) continguous with the first, within which a torque transfer member (30) is placed using a bearing (34) and one or more screws (36) or similar connectors. Additional bushings (e.g., 38, shown in FIG. 1) and/or similar components can be secured between the torque transfer member (30) and the air ratchet (42). A frame having two portions (44, 46) is usable to secure the air ratchet (42) to the body (12), e.g., using one or more screws (50) or similar connectors.

The depicted embodiment is also shown including a reacton frame (62), adapted for securing around the air ratchet (42) and attaching to the body (12) to further stabilize the air ratchet (42) and body (12) and minimize undesired lateral movement thereof. The reaction frame (62) is shown including two side flanges (64A, 64B), which contact the air ratchet (42), the body (12) of the apparatus (10), and/or an adjacent structure (e.g., a conduit, nut, stud, flange, etc.), such that lateral movement of the air ratchet (42) and/or apparatus (10) is limited. In the depicted embodiment, the second side flange (64B) can be secured to a first bore (68) and a second bore (70) disposed along a side of the body (12). The first side flange (64A) can similarly be secured in bores positioned on the opposite side of the body (12). However, it should be understood that the depicted manner of engagement is exemplary, and that any manner of connection between the reaction frame (62) and the apparatus (10) can be used without departing from the scope of the present disclosure. The reaction frame (62) is further shown including a handle (66) used for further stabilization and/or manipulation of the apparatus (10).

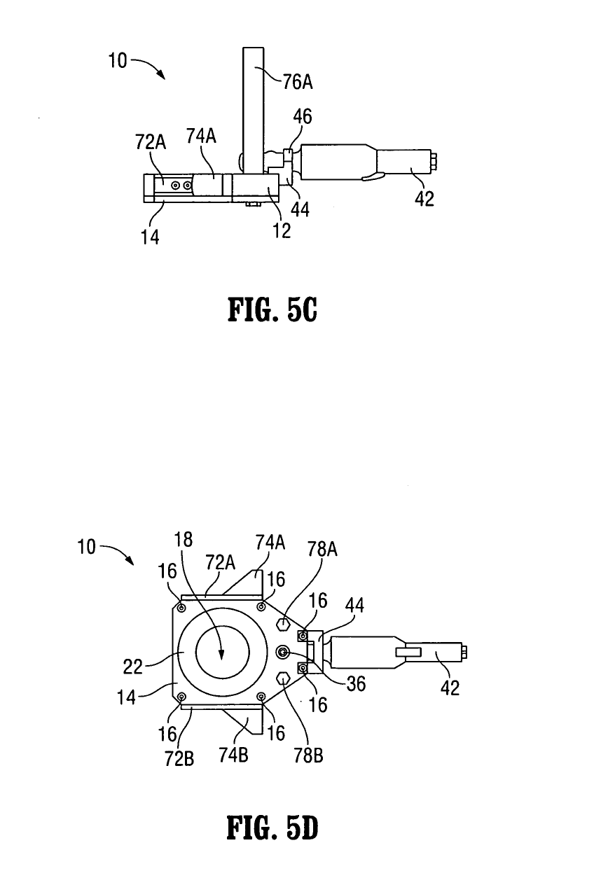

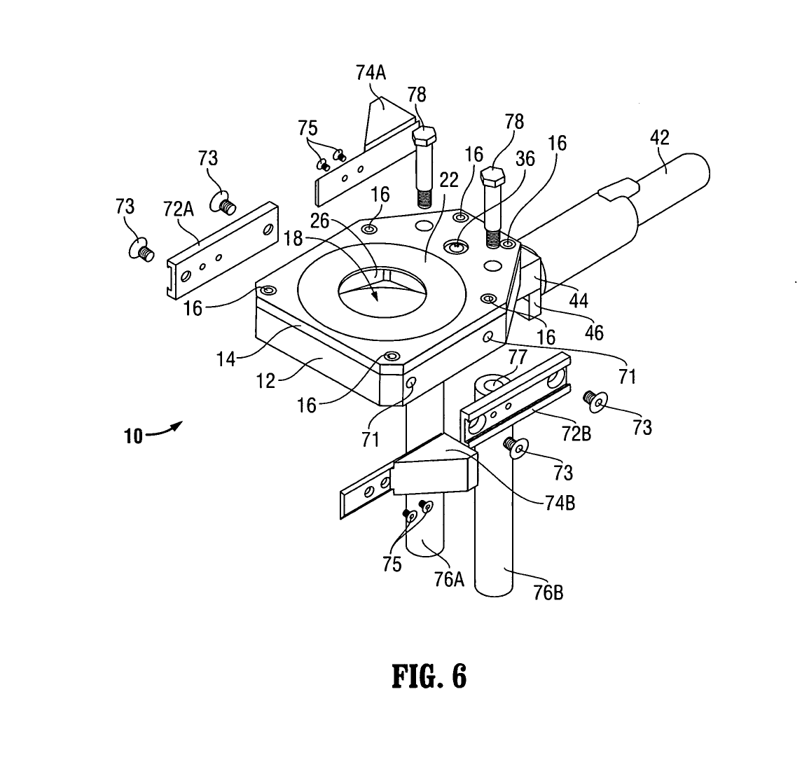

Referring now to FIGS. 5A through 5D, an alternate embodiment of a nut running apparatus (10) is shown. Specifically, FIG. 5A depicts a perspective view of the apparatus (10), while FIG. 5B depicts a top view, FIG. 5C depicts a side view, and FIG. 5D depicts a bottom view thereof FIG. 6 depicts an exploded view of the apparatus (10) shown in FIGS. 5A through 5D.

The nut running apparatus (10) is depicted having a body (12) and top plate (14), connected by screws (16) and/or similar connectors or fasteners, as described previously, the body (12) having an orifice (18) formed therein in which the contact member (22) with a hexagonal contact surface (26) is usable to contact and rotate nuts or other similar objects. A screw (36) and/or similar connector is also visible, usable to secure a torque transfer member (e.g., 30, shown in FIG. 1), within a second orifice (e.g., 20, shown in FIG. 1), such that an air ratchet (42) or similar power source, secured to the apparatus (10) via frame portions (44, 46) and screws (48, 50), can be used to cause rotation of the contact member (22), as described above.

The depicted embodiment further includes channel members (72A, 72B) secured to opposing sides of the body (12), e.g., using screws (73), rivets, bolts, and/or other similar fasteners to engage bores (71) in the body (12). The channel members (72A, 72B) are shown in a position generally perpendicular to the portion of the body (12) that engages the air ratchet (42). Each channel member is shown having a respective blocking member (74A, 74B) secured thereto, the depicted blocking members (74A, 74B) having a complementary elongate portion usable to slidably engage the channel members (72A, 72B), after which screws (75), rivets, bolts, and/or other types of fasteners can be used to secure the blocking members (74A, 74B) relative to the channel members (72A, 72B) and body (12). It should be understood that while FIGS. 5A through 5D and FIG. 6 depict removable channel members (72A, 72B) used to retain the blocking members (74A, 74B), to permit easy attachment; removal, and/or interchanging of the blocking members (74A, 74B), in other embodiments, the blocking members (74A, 74B) could be directly connected to the body (12), or integrally formed with the body (12), and/or the channel members could be integrally formed with the body (12). During operation, the blocking members (74A, 74B) can prevent undesired lateral movement of the air ratchet (42) and/or the apparatus (10), e.g., through contact between the blocking members (74A, 74B) and an adjacent object, such as an adjacent nut, stud, flange, etc. and/or through contact between the blocking members (74A, 74B) and the air ratchet (42). While FIGS. 5A through 5D and FIG. 6 depict two blocking members (74A, 74B) positioned on opposing sides of the apparatus (10), in various embodiments, a single blocking member can be effective for this purpose, and in other embodiments, use of blocking members could be omitted.

The depicted embodiment is also shown having two reaction members (76A, 76B), secured to the body (12), e.g., via threading of bolts (78A, 78B), screws, and/or similar fasteners through corresponding through-bores in the body (12), into receiving bores (77) within the reaction members (76A, 76B). Specifically, the reaction members (76A, 76B) are shown positioned on opposing sides of the air ratchet (42), such that undesired lateral movement of the air ratchet (42) (e.g., upon continued actuation of the air ratchet (42) after abutment of a nut against a flange), is restricted through contact between the air ratchet (42) and the reaction members (76A, 76B), and/or through contact between the reaction members (76A, 76B) and an object adjacent to the apparatus (10). While FIGS. 5A through 5D and FIG. 6 depict two reaction members (76A, 76B) positioned on opposing sides of the air ratchet (42), in various embodiments, a single reaction member can be effective for this purpose, and in other embodiments, use of reaction members could be omitted. As such, while FIGS. 5A through 5D and FIG. 6 show two blocking members (74A, 74B) and two reaction members (76A, 76B), any combination of the four depicted members (74A, 74B, 76A, 76B) could be used without departing from the scope of the present disclosure, and in other embodiments, use of blocking and reaction members could be omitted.

The present disclosure thereby provides apparatus and methods usable to rapidly move nuts along a stud or similar elongate member, bidirectionally, that are usable within limited access and/or low clearance areas, and that can include blocking and/or reaction members or similar features for limiting undesired movement of the apparatus and ferromagnetic members for preventing loss of the nut.

While various embodiments usable within the scope of the present disclosure have been described with emphasis, it should be understood that within the scope of the appended claims, the present invention can be practiced other than as specifically described herein.

What is claimed is:

1. An apparatus for threading a nut along an elongate member, the apparatus comprising:
a body comprising a first side and a second side and having first orifice and a second orifice formed therein;
a contact member disposed within the first orifice for engaging the nut and transferring torque thereto, wherein the first orifice includes a through bore extending from the first side to the second side for accommodating passage of the elongate member; and
a torque transfer member disposed within the second orifice in association with the contact member, wherein the torque transfer member is configured to receive torque from a power source positioned in association with the second orifice,
wherein torque from the power source causes movement of the torque transfer member, and wherein movement of the torque transfer member causes movement of the contact member, thereby causing movement of the nut along the elongate member.

2. The apparatus of claim 1, wherein the body comprises a first end having a first width and having the first orifice therein, and a second end having a second width less than the first width and having the second orifice therein.

3. The apparatus of claim 1, further comprising the power source fixedly engaged with the torque transfer member through the second orifice.

4. The apparatus of claim 1, wherein the contact member comprises a plurality of teeth formed on an external surface thereof, and wherein the plurality of teeth engage a plurality of teeth formed on the torque transfer member.

5. The apparatus of claim 1, wherein the contact member comprises an inner surface having a shape complementary to the shape of the nut.

6. The apparatus of claim 1, wherein the contact member comprises at least one ferromagnetic member for retaining the nut in association therewith.

7. The apparatus of claim 1, further comprising at least one blocking member positioned on a side of the second orifice for limiting movement of the power source relative to the body, for limiting movement of the body, or combinations thereof.

8. The apparatus of claim 1, wherein the contact member and the torque transfer member are each rotatably movable in both a clockwise direction and a counterclockwise direction.

9. The apparatus of claim 1, wherein the body comprises a height less than or equal to a height of the nut.

10. The apparatus of claim 1, wherein the power source comprises a pneumatic power source.

11. The apparatus of claim 1, wherein the body comprises a width adapted for insertion between a first nut and a second nut positioned on a flange, wherein a distance between a first nut and a second nut is determined by an API specification, an ANSI specification, or combinations thereof.

12. A method for threading a nut along an elongate member, the method comprising the steps of:
engaging a nut with a contact member of an apparatus;
providing a power source in engagement with a torque transfer member of the apparatus, wherein the torque transfer member is movably engaged with the contact member;
actuating the power source to cause movement of the torque transfer member, thereby causing movement of the contact member, wherein the contact member contacts and moves the nut along the elongate member, and wherein the elongate member passes through a through bore of the apparatus.

13. The method of claim 12, wherein the step of engaging the nut with the contact member comprises positioning the nut within an orifice of the contact member, wherein at least one ferromagnetic member within the contact member retains the nut within the orifice.

14. The method of claim 12, wherein the step of actuating the power source causes movement of the nut along the elongate member in a first direction, the method further comprising the step of actuating the power source to cause movement of the torque transfer member in reverse direction, thereby causing movement of the contact member, wherein the contact member contacts and moves the nut along the elongate member in a second direction opposite the first direction.

15. The method of claim 12, further comprising the step of contacting the power source, the apparatus, or combinations thereof with at least one blocking member to limit movement of the power source relative to the apparatus, the elongate member, or combinations thereof.

16. The method of claim 12, wherein the step of actuating the power source comprises moving the nut along the elongate member into contact with an additional object, and wherein the additional object prevents further movement of the nut along the elongate member such that continued actuation of the power source transfers force through the nut to cause movement of the elongate member.

17. An apparatus for applying torque to an object, the apparatus comprising:
a body having a through bore sized for engagement with the object and a movable member positioned in association with the through bore for applying a force to the object; and
a power source engaged with the movable member and adapted for imparting a force thereto, wherein the movable member transmits force from the power source to the object.

18. The apparatus of claim 17, further comprising at least one ferromagnetic member positioned in association with the through bore for retaining the object therein.

19. The apparatus of claim 17, further comprising at least one blocking member secured to the body proximate to a side of the power source, wherein contact between said at least one blocking member and the power source limits movement of the power source relative to the body.

20. The apparatus of claim 17, wherein the body comprises a height less than or equal to a height of the object for facilitating access of the body within a low clearance or limited access space.
